(19) United States
(12) Patent Application Publication
(10) Pub. No.: US 2016/0267393 A1
(43) Pub. Date: Sep. 15, 2016

(54) METHOD OF CONSTRUCTION AND SELECTION OF PROBALISTIC GRAPHICAL MODELS

(71) Applicant: GE AVIATION SYSTEMS LIMITED, Gloucestershire (GB)

(72) Inventors: Paul BUTTERLEY, Eastleigh, Hampshire (GB); Robert Edward CALLAN, Southampton, Hampshire (GB); Olivier Paul Jacques Thanh Minh THUONG, Eastleigh, Hampshire (GB)

(21) Appl. No.: 15/033,159

(22) PCT Filed: Oct. 30, 2013
(86) PCT No.: PCT/GB2013/052830

§ 371 Date: Apr. 29, 2016

(51) Int. Cl. G06N 7/00; G06F 17/50; G06N 99/00

(52) U.S. Cl. CPC G06N 7/005; G06N 99/005; G06F 17/50

(57) ABSTRACT

A method of automatically constructing probabilistic graphical models from a source of data for user selection includes: providing in memory a predefined catalog of graphical model structures based on node types and relations among node types; selecting by user input specified node types and relations; automatically creating, in a processor, model structures from the predefined catalog of graphical model structures and the source of data based on user selected node types and relations; automatically evaluating, in the processor, the created model structures based on a predefined metric; automatically building, in the processor, a probabilistic graphical model for each created model structure based on the evaluations; calculating a value of the predefined metric for each probabilistic graphical model; scoring each probabilistic graphical model based on the calculated metric; and presenting to the user each probabilistic graphical model with an associated score for selection by the user.

### BACKGROUND

Probabilistic Graphical Models (PGMs) are used for a wide range of applications, such as speech recognition, health diagnostics, computer vision and decision support. Probabilistic Graphical Models (PGMs) provide a graph-based representation of the conditional dependence structure between random variables. Further described by C. M. Bishop in Chapter 8 of Pattern Recognition and Machine Learning, Springer, (2006), PGMs are probabilistic models but their structure can be visualized which allows independence properties to be deduced by inspection. Variables (such as features) are represented by nodes and associations between variables represented by edges.

However, choosing a structure for a PGM requires a large number of decisions, and engineers may not have the expertise in machine learning necessary for choosing the optimal structure, or the time to build, train and compare all possible structures. Therefore, engineers may benefit from a tool that enables them to easily choose from a set of candidate networks structures and then obtain a direct data-based assessment of which of them is optimal.

An example of this is the case of a company managing a fleet of jet engines (or any other type of assets) that wishes to monitor the health of the engines. Engineers have developed feature extraction algorithms that analyze the performance data obtained from the assets and identify features such as shifts, trends, abnormal values, unusual combinations of parameter values, etc. PGMs can then be used as classifiers to analyze the features and determine the nature of the event that occurred. For example, they may determine whether a fault is likely to have caused those features, and, subsequently, the most probable nature of the fault.

While engineers may have a large amount of domain knowledge, they may not know how to translate the knowledge into a model structure. For example, they may know that when a particular fault occurs, one of the performance parameters usually shifts up or down by a specific amount, while another of the parameters always shifts up, but not always by the same amount. An engineer may be lacking in the support needed in deciding on the appropriate structure for a model.

### BRIEF DESCRIPTION

One aspect of the innovation relates to a method of automatically constructing probabilistic graphical models from a source of data for user selection. The method includes: providing in memory a predefined catalog of graphical model structures based on node types and relations among node types; selecting by user input specified node types and relations; automatically creating, in a processor, model structures from the predefined catalog of graphical model structures and the source of data based on user selected node types and relations; automatically evaluating, in the processor, the created model structures based on a predefined metric; automatically building, in the processor, a probabilistic graphical model for each created model structure based on the evaluations; calculating a value of the predefined metric for each probabilistic graphical model; scoring each probabilistic graphical model based on the calculated metric; and presenting to the user each probabilistic graphical model with an associated score for selection by the user.

### BRIEF DESCRIPTION OF THE DRAWINGS

In the drawings:

FIG. 1 shows a flowchart of a method for automatically constructing and selecting PGMs according to various aspects described herein.

### DETAILED DESCRIPTION

In the background and the following description, for the purposes of explanation, numerous specific details are set forth in order to provide a thorough understanding of the technology described herein. It will be evident to one skilled in the art, however, that the exemplary embodiments may be practiced without these specific details. In other instances, structures and devices are shown in diagram form in order to facilitate description of the exemplary embodiments.

The exemplary embodiments are described with reference to the drawings. These drawings illustrate certain details of specific embodiments that implement a module, method, or computer program product described herein. However, the drawings should not be construed as imposing any limitations that may be present in the drawings. The method and computer program product may be provided on any machine-readable media for accomplishing their operations. The embodiments may be implemented using an existing computer processor, or by a special purpose computer processor incorporated for this or another purpose, or by a hardwired system.

As noted above, embodiments described herein may include a computer program product comprising machine-readable media for carrying or having machine-executable instructions or data structures stored thereon. Such machine-readable media can be any available media, which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium that can be used to carry or store desired program code in the form of machine-executable instructions or data structures and that can be accessed by a general purpose or special purpose computer or other machine with a processor. When information is transferred or provided over a network or another communication connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data, which cause a general purpose computer, special purpose computer, or special purpose processing machines to perform a certain function or group of functions.

Embodiments will be described in the general context of method steps that may be implemented in one embodiment by a program product including machine-executable instructions, such as program codes, for example, in the form of program modules executed by machines in networked environments. Generally, program modules include routines, programs, objects, components, data structures, etc. that have the technical effect of performing particular tasks or implement particular abstract data types. Machine-executable instructions, associated data structures, and program modules represent examples of program codes for executing steps of the method disclosed herein. The particular sequence of such executable instructions or associated data structures represent examples of corresponding acts for implementing the functions described in such steps.

Embodiments may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the internet and may use a wide variety of different communication protocols. Those skilled in the art will appreciate that such network computing environments will typically encompass many types of computer system configurations, including personal computers, hand-held devices, multiprocessor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination of hardwired or wireless links) through a communication network. In a distributed computing environment, program modules may be located in both local and remote memory storage devices.

An exemplary system for implementing the overall or portions of the exemplary embodiments might include a general purpose computing device in the form of a computer, including a processing unit, a system memory, and a system bus, that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD-ROM or other optical media. The drives and their associated machine-readable media provide nonvolatile storage of machine-executable instructions, data structures, program modules and other data for the computer.

Technical effects of the method include the provision of a tool that enables engineers to easily choose from a set of candidate networks structures and then obtain a direct data-based assessment of which of them is optimal. Consequently, useful PGMs may be built by people who are not machine learning specialists. Incorporating catalogs of structures predefined by machine learning experts to choose the candidate structures, automation of the selection, evaluation and optimization of models accelerates the deployment of PGMs into a new system.

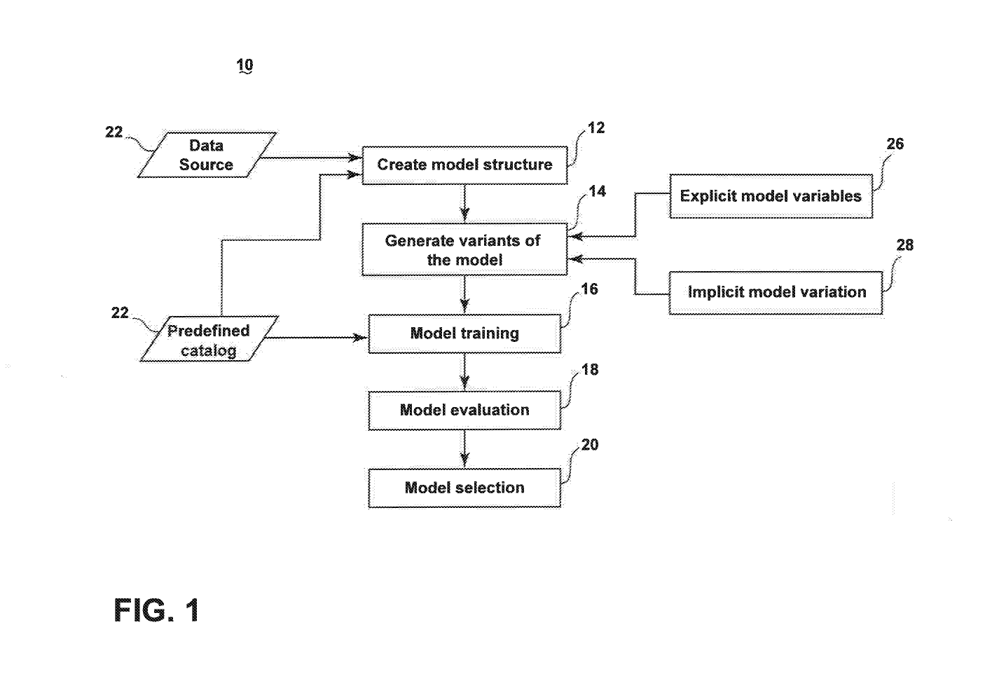

Referring now to FIG. 1, an embodiment of the innovation includes a method 10 of automating elements of the construction and selection of PGMs. The method 10 includes the steps of creating model structures 12 using a data source 22 and a predefined catalog 24 of graphical models. As shown in FIG. 1, the method 10 may include a step of generation of variants of the models 14. The variants may come from two main sources: explicit model variables 26 and implicit model variation 28. The method 10 may include the step of model training 16 that may include training algorithms specifically modified for the structure chosen from the catalog 24 the step of creating the model structures 12. A step of model evaluation 18 includes analytic techniques such as cross validation with an appropriate metric so that a best model can be selected at step 20.

Not all of these steps are required, and they are not necessarily sequential; the order described and shown in FIG. 1 is not limiting. For example, a procedural approach may step backwards based on the results of one step in order to iterate and find new models. Each of the steps of the method 10 is described in further detail below.

The step to create a model structure 12 includes input from a predefined catalog 24 of model structures. The predefined catalog 24 of model structures includes, for example Naïve Bayes, Gaussian Mixture, as well as bespoke types built for specific applications. Each graphical model structure may be separated into node types and relations. The method can build the graphical model when it is given nodes with specified node types and relations, as might occur, for example, by user input. Node types typically represent nodes in a graph that perform a distinct function, and relations are a group of node types that may be replicated across the graph.

The step to create a model structure 12 also includes input from a data source 22. During the step to create a model structure 12, columns in the data source may be tagged with prefixes or suffixes to automatically determine the node type and relation of each column and thus build the graphical model. The prefix or suffix tags associated with particular node types, and any column names that are the same apart from the prefix or suffix are considered to be part of the same relation.

With a basic model structure 12 in place, a step to generate variants of the model 14 may adjust aspects of the model to improve it. Inputs to the step to generate variants of the model 14 may include explicit model variation 26 and implicit model variation 28.

Explicit model variation 26 refers to defining model parameters that may be adjusted. For example in a Gaussian Mixture Model, the number of mixture components may be varied. Or, in a Hidden Markov Model, the number of latent states may be varied. Varying these types of parameters is generally simple and is implemented with an iterative loop over each parameter, creating a new model for each loop iteration.

Implicit model variation 28 refers to intelligent adjustments to the model that are not defined as parameters. Implicit model variation 28 includes analysis of both the model and the data and determining if structure alteration techniques improve the model. One example, if there is insufficient data to estimate the conditional probability distributions, includes analyzing the number of data cases for combinations of discrete nodes and performing techniques known in the art of machine learning for the manipulation of the nodes of a PGM. Techniques include, but are not limited to, ‘divorcing’, ‘noisy-OR’ and ‘noisy-AND’. Another technique used for implicit model variation 28 includes identifying continuous nodes with discrete child nodes and adjusting the structure of the model to simulate these. As described above as a benefit of the innovation, these are the types of automatic adjustments that allow an unskilled user who is not familiar with the concepts of machine learning and PGMs to overcome modeling problems that he or she may not have even been aware of in the first place.

Referring now to the step of model training 16, rather than simply applying an algorithm such as Expectation-Maximization to learn the models, each model type in the predefined catalog 24 may have its own training algorithm. Each training algorithm may have a number of parameters. In this way, prior knowledge of the types of models improves the parameter estimation of the model structure. For example, known restrictions on a particular conditional probability distribution associated with a model in the predefined catalog 24 may determine aspects of the training algorithm used in the step of model training 16. In another example, prior knowledge that a certain model type may converge to different parameters with different random seeds may determine a step of model training 16 where the model is trained multiple times. In this example, the step of model training 16 may include an automatic assessment of the differences in parameters to determine a result of multiple trained models connected by a technique of fusion.

A selection of models created from the data source, along with the variants that have been generated are input to the step of model evaluation 18. The step of model evaluation 18 takes these inputs and assesses which model is the ‘best’, where ‘best’ refers to some choice of metric. For example, for model structures solving classifier problems, the models are tested against the associated data 22 to perform cross-validation using the area under curve as the metric.

Consequently, the method 10 of the present innovation builds each model with its variants, calculates the value of the metric, and returns a score of each model, preferably along with other useful information such as training time, etc. Based upon the results of the step of model evaluation 18, a model may be selected as an overall output of the method 10 of the present innovation. This allows non-experts in the field of probabilistic graphical models (PGMs) to experiment with different model types without extensive training or self-studying.

This written description uses examples to disclose the innovation, including the best mode, and also to enable any person skilled in the art to practice the innovation, including making and using any devices or systems and performing any incorporated methods. The patentable scope of the innovation is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of automatically constructing probabilistic graphical models from a source of data in a memory location for user selection, the method comprising:
providing in memory a predefined catalog of graphical model structures based on node types and relations among node types;
selecting by user input specified node types and relations;
automatically creating, in a processor, model structures from the predefined catalog of graphical model structures and the source of data based on user selected node types and relations;
automatically evaluating, in the processor, the created model structures based on a predefined metric;
automatically building, in the processor, a probabilistic graphical model for each created model structure based on the evaluations;
calculating a value of the predefined metric for each probabilistic graphical model;
scoring each probabilistic graphical model based on the calculated metric; and
presenting to the user each probabilistic graphical model with an associated score for selection by the user.

2. The method of claim 1, further comprising automatically generating, in a processor, variants of the created model structures.

3. The method of claim 2, wherein automatically generating variants of the model structures includes explicit model variation.

4. The method of claim 3, wherein the explicit model variation includes varying the number of mixture components of a created model structure.

5. The method of claim 2, to wherein automatically generating variants of the model structures includes implicit model variation.

6. The method of claim 5, wherein the implicit model variation includes at least one of a divorcing, noisy-OR, or a noisy-AND structure alteration technique.

7. The method of claim 1, wherein the created model structure is one of a Gaussian Mixture Model or a Hidden Markov Model.

8. The method of claim 1, further comprising training the created model structure.

9. The method of claim 8, wherein training the created model structure includes using a training algorithm specifically modified for a graphical model structure of the predefined catalog.

10. The method of claim 1 wherein scoring each probabilistic graphic model is performed by cross-validation.
